(19) United States
(12) Patent Application Publication
(10) Pub. No.: US 2010/0175632 A1
(43) Pub. Date: Jul. 15, 2010

(54) Modular Animal Containment Panels Adapted for Post-Manufacture Assembly

(76) Inventor: William S. Groh, Knoxville, TN (US)

Correspondence Address: PITTS AND BRITTIAN P C, P O BOX 51295, KNOXVILLE, TN, 37950-1295, US

(21) Appl. No.: 12/352,808

(22) Filed: Jan. 13, 2009

(51) Int. Cl. A01K 1/02; A01K 1/00; E04H 17/16

(52) U.S. Cl. 119/474; 119/498; 256/25

(57) ABSTRACT

Described is a welded wire mesh-based modular animal containment panel adapted for post-manufacture assembly. More specifically, the modular animal containment panel includes a welded wire mesh panel that provides the durability required by animal containment. However, the frame of the animal containment panel is adapted to receive the welded wire mesh panel such that the welded wire mesh panel is not welded to the frame. As a result, the animal containment panel can be assembled by, for example, a consumer such that the animal containment panel can be shipped prior to assembly. Shipping the animal containment panel in a disassembled state reduces the size of the packaging required for the animal containment panel, thus reducing the cost of shipping and storing the animal containment panel.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention pertains to a wire mesh-based modular animal containment panel that is adapted for post-manufacture assembly.

2. Description of the Related Art

Modular animal containment is a convenient means for providing nonpermanent containment of an animal. Conventional modular animal containment systems include a plurality of modular panels, each panel being secured to one or more adjacent panels such that the panels define a containment area. The panels are constructed to have of sufficient size and durability to contain an animal within the containment area. FIG. 1 illustrates an exploded view of a conventional modular panel 01 commonly used in animal containment. Conventional modular panels 01 include a metallic frame 03 and a welded wire mesh panel 05, the welded wire mesh panel 05 providing the durability required by most animal containment. The metallic frame 03 is welded together and welded to the welded wire mesh panel 05 where indicated by the broken lines of FIG. 1. Because conventional modular panels 01 are assembled by weld, the panels 01 must be assembled at the manufacture stage, which is prior to shipping to distributors or consumers. Because conventional panels 01 are assembled prior to shipping, much space is wasted in the shipping package containing the panels 01. For example, FIG. 2 illustrates a sectional view of a shipping package 07 containing conventional modular panels 01. In the illustrated embodiment, the package 07 includes six conventional panels 01. Because the depth d of the metallic frame 03 is substantially greater than that of the welded wire mesh panel 05, unutilized space 09 is defined between each of the packaged mesh panels 05. This unutilized space 09 increases the cost shipping the conventional modular panels 01 and causes the package 07 to be more difficult manage for both distributors and consumers. Consequently, a modular animal containment panel that is adapted to be assembled by, for example, a consumer such that the animal containment panel can be shipped and stored in a disassembled state is desired.

### BRIEF SUMMARY OF THE INVENTION

In accordance with the various features of the present invention there is provided a welded wire mesh-based modular animal containment panel adapted for post-manufacture assembly. The modular animal containment panel includes a frame and a welded wire mesh panel. The welded wire mesh panel is constructed of a plurality of overlaying wires, which includes a plurality of perimeter wires. Each of the perimeter wires defines a side of the perimeter of the welded wire mesh panel. The frame includes a plurality of frame members, each frame member corresponding to a side of the perimeter of the welded wire mesh panel. Each frame member defines a groove and a channel adapted to receive the perimeter wire defining the corresponding side of the perimeter of the welded wire mesh panel. When a frame member has received its respective perimeter wire, the frame member is secured to the welded wire mesh panel. The frame members are adapted to cooperate with one another when secured to the welded wire mesh panel such that the frame is secured to the welded wire mesh panel without having to be welded to the panel. As a result, the modular animal containment panel can be assembled without welding the frame to the welded wire mesh panel. This enables, for example, a consumer to assemble to modular animal containment panel such that the animal containment panel can be shipped and stored in a disassembled state. Being shipped and stored in a disassembled state reduces the size of the required packaging, which, in turn, reduces the cost of shipping and storing the modular animal containment panel.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates a conventional modular animal containment panel that is part of the prior art;

FIG. 2 illustrates a plurality of conventional modular animal containment panels packaged for shipping and/or storage;

FIG. 3 illustrates a plurality of one embodiment of the modular animal containment panel defining an animal containment area;

FIG. 4 illustrates one embodiment of the welded wire mesh panel of the modular animal containment panel of FIG. 1;

FIG. 5 illustrates one embodiment of a frame member of the modular animal containment panel of FIG. 1;

FIG. 6 illustrates one embodiment of a frame member receiving the welded wire mesh panel;

FIGS. 7a-7b illustrate the assembly of one embodiment of the modular animal containment panel;

FIG. 8 illustrates an alternate embodiment of the frame having a joinder frame member; and

FIG. 9 illustrates one embodiment of the joinder frame member in accordance with the various features of the present invention.

### DETAILED DESCRIPTION OF THE INVENTION

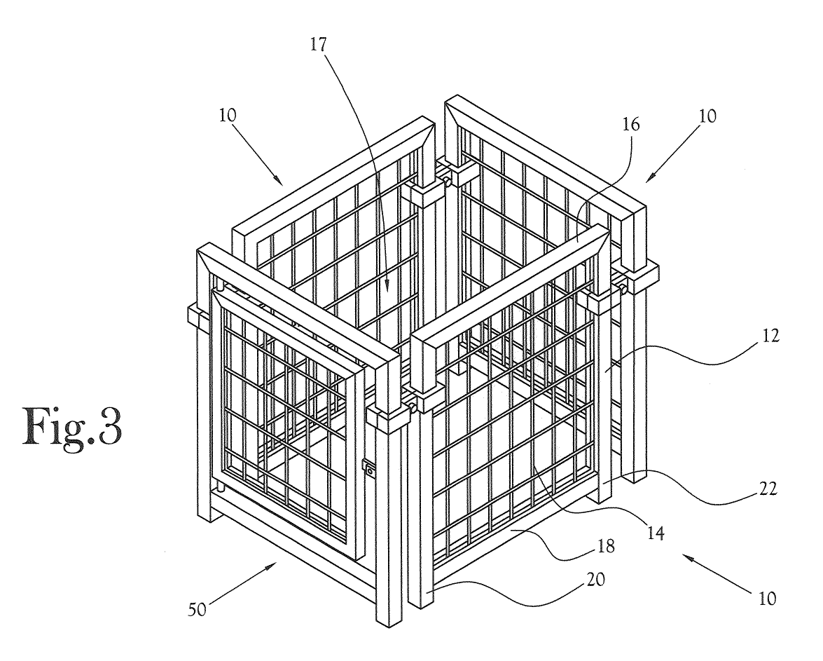

The present invention provides a welded wire mesh-based modular animal containment panel adapted for post-manufacture assembly. More specifically, the modular animal containment panel includes a welded wire mesh panel that provides the durability required by animal containment. However, the frame of the animal containment panel is adapted to receive the welded wire mesh panel such that the welded wire mesh panel is not welded to the frame. As a result, the animal containment panel can be assembled by, for example, a consumer such that the animal containment panel can be shipped prior to assembly. Shipping the animal containment panel in a disassembled state reduces the size of the packaging required for the animal containment panel, thus reducing the cost of shipping and storing the animal containment panel. One embodiment of a modular animal containment panel constructed in accordance with the various features of the present invention is illustrated generally at 10 in FIG. 3.

In the illustrated embodiment, three of the modular animal containment panels 10 and one gate panel 50 are connected using clamps 11 such that the modular animal containment panels 10 and the gate panel 50 define a containment area 17, the containment area 17 being the area within which an animal is contained. The gate panel 50 includes a gate that is moveable between an open position and a closed position such that the gate panel 50 provides an animal ingress and egress with respect to the containment area 17. The modular animal containment panel 10 includes a frame 12 and a welded wire mesh panel 14. In the illustrated embodiment, the frame 12 includes a top frame member 16, a bottom frame member 18, a first side frame member 20, and the second side frame member 22. Each of the frame members 16-22 receives the welded wire mesh panel 14 such that the frame 12 is secured to the mesh panel 14 without being welded thereto. Because the frame 12 is not welded to the welded wire mesh panel 14, the frame 12 can be constructed of any substantially rigid material. For example, the frame 12 can be constructed of a plastic or a metal. When the frame 12 is constructed of a plastic, the overall weight of the animal containment panel 10, as compared to the all-metal conventional animal containment panels, is substantially reduced. The reduced weight of the animal containment panel 10 further reduces the costs associated with shipping and storing the panel 10.

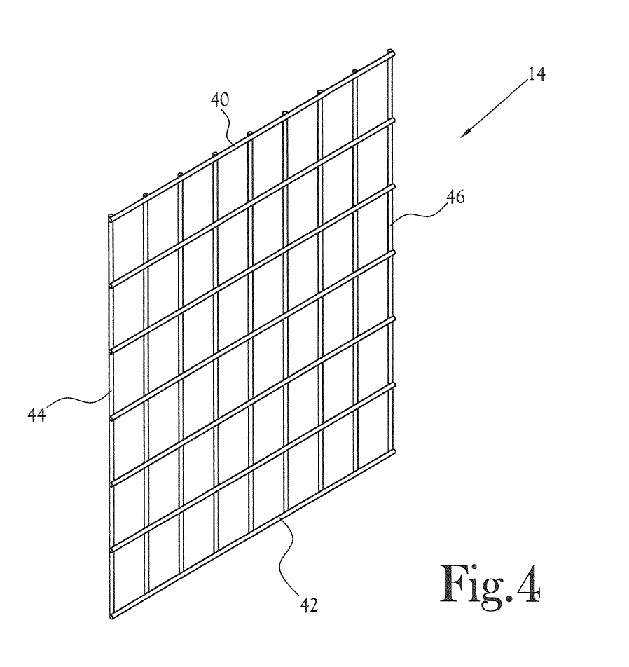

FIG. 4 illustrates one embodiment of the welded wire mesh panel 14 in accordance with the various features of the present invention. The welded wire mesh panel 14 is constructed of a plurality of overlaying wires welded to one another at the various contact points. In the illustrated embodiment, the welded wire mesh panel 14 is constructed of a plurality of evenly spaced horizontal wires overlayed by a plurality of evenly spaced vertical wires. The horizontal wires and the vertical wires are welded to one another at the contact points such that the wires of the welded wire mesh panel 14 define a grid-type structure. Each side of the perimeter of the welded wire mesh panel 14 is defined by one of the plurality of overlaying wires. In the illustrated embodiment, the perimeter of the welded wire mesh panel 14 is of a rectangular contour and is defined by a top perimeter wire 40, a bottom perimeter wire 42, a first side perimeter wire 44, and a second side perimeter 46. The top perimeter wire 40 and the bottom perimeter wire 42 are two of the plurality of horizontal wires, and the first side perimeter wire 44 and the second side perimeter wire 46 are two of the plurality of vertical wires. The top frame member 16 is adapted to receive the top perimeter wire 40, the bottom frame member 18 is adapted to receive the bottom perimeter wire 42, the first side frame member 20 is adapted to receive the first side perimeter wire 44, and the second side frame member 22 is adapted to receive the second side perimeter wire 46. It should be noted that the configuration of the plurality of overlaying wires and the contour of the perimeter can differ from that of the illustrated embodiment without departing from the scope or spirit of the present invention.

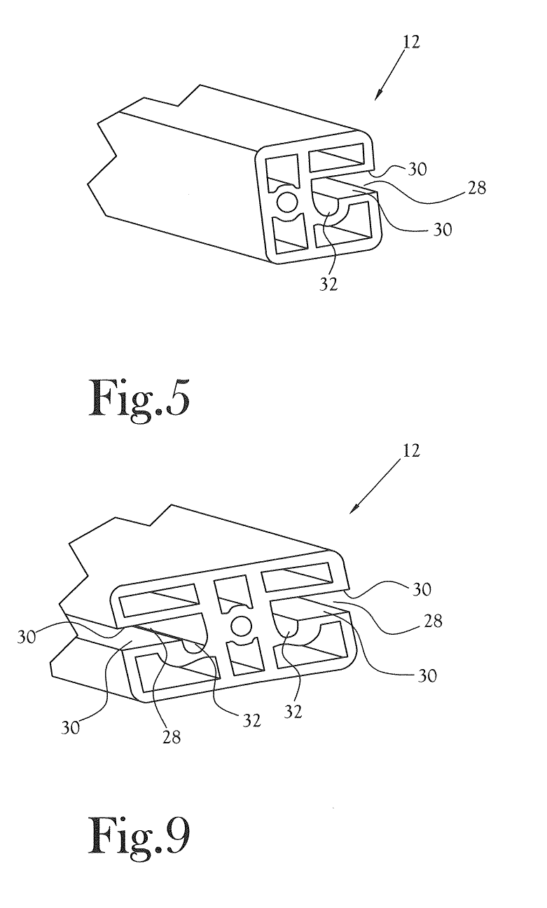

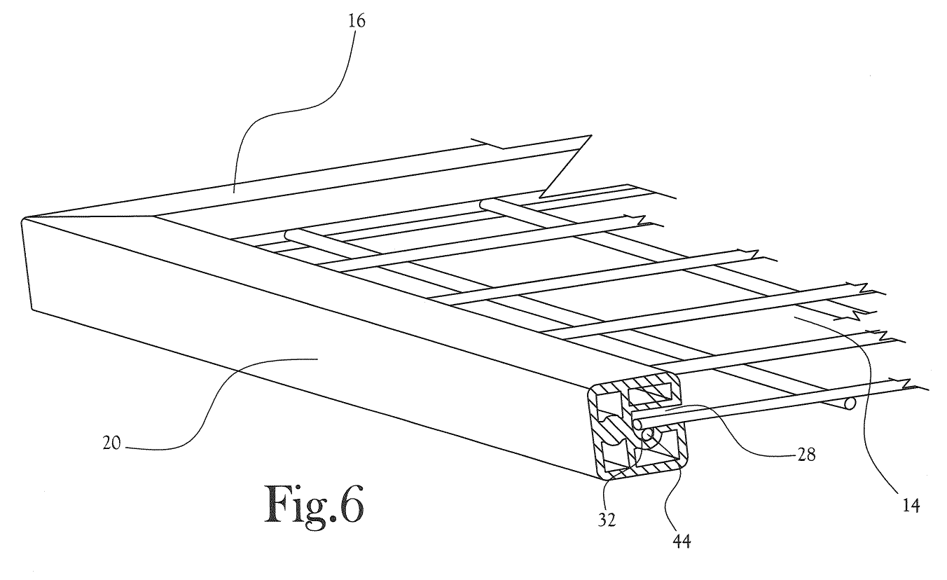

FIG. 5 illustrates one embodiment of one of the frame members 16-22 constructed in accordance with the various features of the present invention. Each of the frame members 16-22 defines a groove 28 and a channel 32 that extend longitudinally along the frame member. The groove 28 defines two sidewalls 30, and the channel 32 is defined along one of the sidewalls 30. The groove 28, in conjunction with the channel 32, is adapted to receive the welded wire mesh panel 14 at the perimeter thereof. For example, consider FIG. 6, which illustrates the first side frame member 20 receiving the perimeter of the welded wire mesh panel 14 at the first side perimeter wire 44. Each channel 32 is adapted to receive a respective one of the perimeter wires 40-46. Accordingly, the channel 32 is substantially the size and contour of the perimeter wire received thereby. In the illustrated embodiment, the channel 32 of the first side frame member 20 is substantially the size and contour of the first side perimeter wire 44. Additionally, the width of the groove 28, that is, the distance between the sidewalls 30, is substantially the diameter of the wires of the welded wire mesh panel 14 that are welded to the perimeter wire received by the corresponding channel 32. In the illustrated embodiment, the width of the groove 28 of the first side frame member 20 is substantially the diameter of each of the plurality of horizontal wires of the welded wire mesh panel 14.

Because the welded wire mesh panel 14 is constructed using overlaying wires, there is a positional difference between the horizontal wires and the vertical wires with respect to the depth of animal containment panel 10. The combined groove 28 and channel 32 utilize this positional difference to secure each of the frame members 16-22 to the mesh panel 14. More specifically, when one of the perimeter wires 40-46 is received by one of the frame members 16-22, the perimeter wire is positioned substantially within the channel 32 and the wires welded to the received perimeter wire extend from the frame member through the groove 28. Because the width of the groove 28 is substantially the diameter of the wires extending therethrough, the received perimeter wire, and consequently the welded wire mesh panel 14, cannot be pulled from the frame member by way of the groove 28. Accordingly, each of the frame members 16-22 receives the welded wire mesh panel 14 when an end of the corresponding one of the perimeter wires 40-26 is inserted into an end of the corresponding channel 32, and either the frame member or the mesh panel 14 is moved with respect to the other such that the perimeter wire is disposed within the channel 32, as is illustrated at FIGS. 3 and 5.

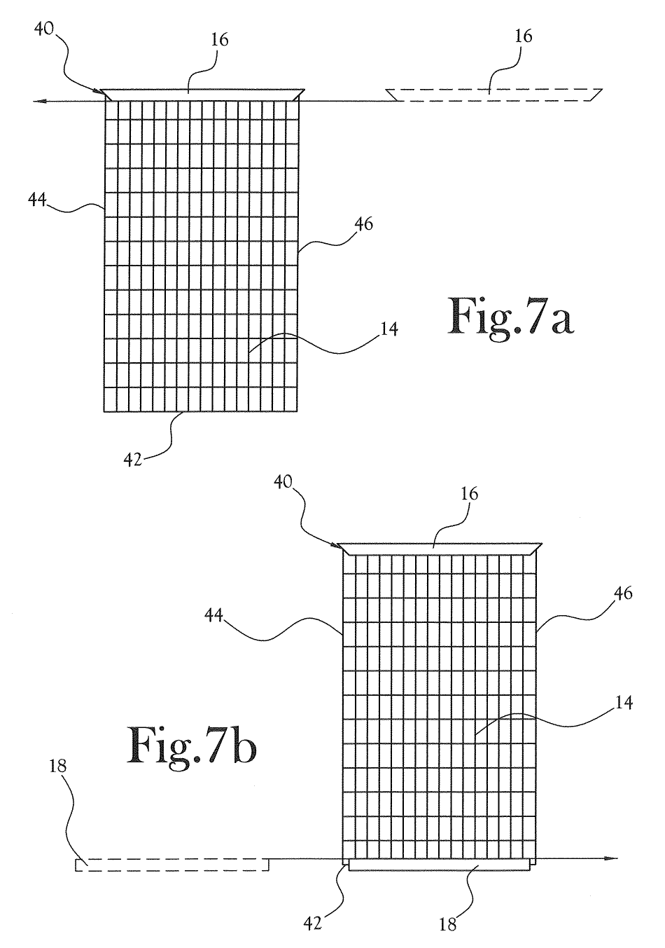

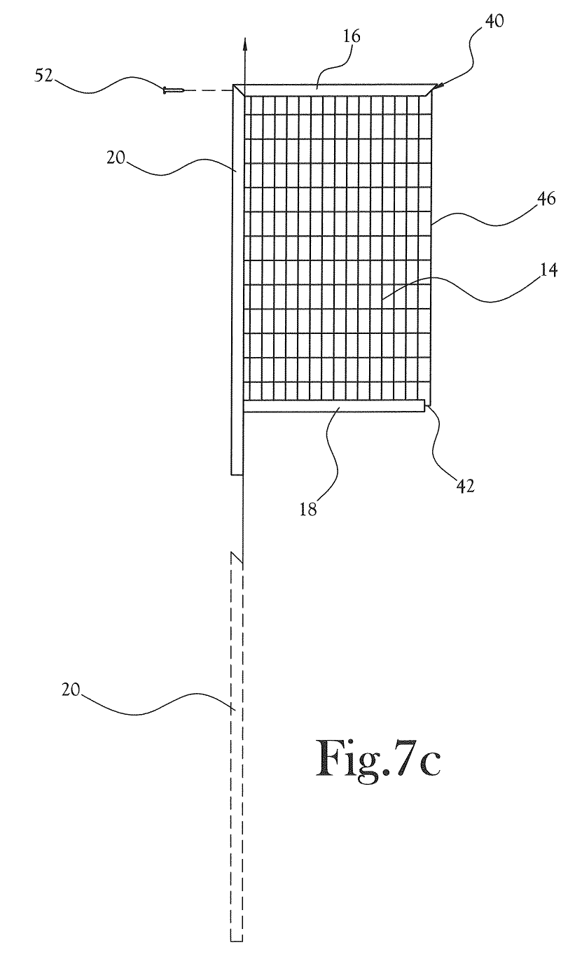

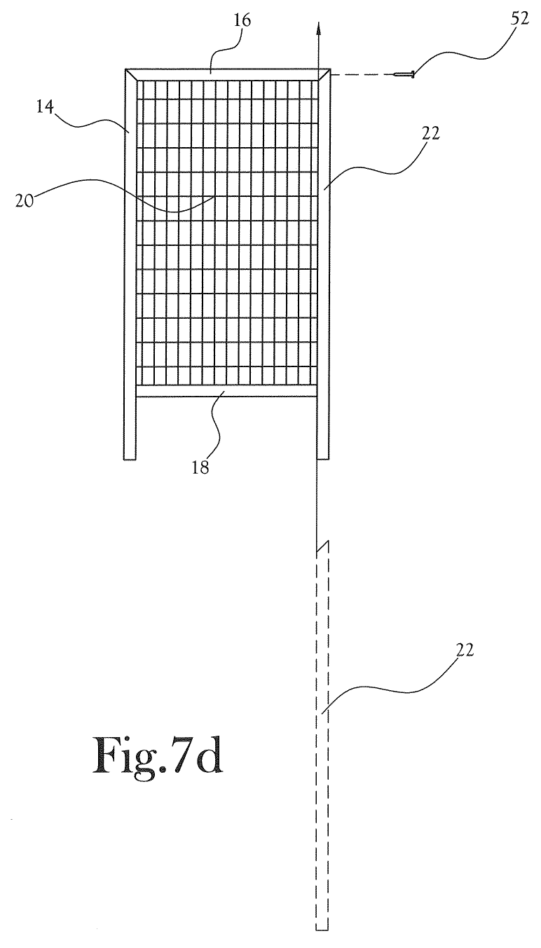

FIGS. 7a-7b illustrate the assembly of one embodiment of the modular animal containment panel 10 in accordance with the various features of the present invention. FIG. 7a illustrates the top frame member 16 receiving the top perimeter wire 40. It should be noted that the portion of the top frame member 16 that defines the groove 28 has a length substantially that of the top perimeter wire 40. FIG. 7b illustrates the bottom frame member 18 receiving the bottom perimeter wire 42. It should be noted that the bottom frame member 18 has a length less than that of the bottom perimeter wire 42. FIG. 7c illustrates the first side frame member 20 receiving the first side perimeter wire 44. Because the bottom frame member 18 has a length less than that of the bottom perimeter wire 42, the first side frame member 20 can receive the first side perimeter wire 44 when the mesh panel 14 is received by the bottom frame member 18. It should be noted that the first side frame member 20 and the top frame member 16 are contoured to cooperate with one another to frame the welded wire mesh panel 14. In the illustrated embodiment, the first side frame member 20 and the top frame member 16 are secured to one another using a screw 52. However, it should be noted that the top frame member 16 and the first side frame member 20 can be secured to one another by a fastener other than a screw without departing from the scope or spirit of the present invention.

FIG. 7d illustrates the second side frame member 22 receiving the second side perimeter wire 46. Because the bottom frame member 18 has a length less than that of the bottom perimeter wire 42, the second side frame member 22 can receive the second side perimeter wire 46. Similar to the first side frame member 20, the second side frame member 22 and the top frame member 16 are contoured to cooperate with one another to frame the welded wire mesh panel 14. In the illustrated embodiment, the second side frame member 22 and the top frame member 16 are secured to one another using a screw 52. However, it should be noted that the top frame member 16 and the first side frame member 20 can be secured to one another by a fastener other than a screw without departing from the scope or spirit of the present invention. When the side frame members 20, 22 receive the respective side perimeter wires 44, 46 and are secured to the top frame member 16, the side frame members 20, 22 prevent the bottom frame member 18 from disengaging from the mesh panel 14. As a result, in the illustrated embodiment, the frame 12 is secured to the welded wire mesh panel 14, and the modular animal containment panel 10 is assembled, when the side frame members 20, 22 receive the respective side perimeter wires 44, 46 and are secured to the top frame member 16.

In one embodiment, the groove 28 of the bottom frame member 18 and the groove 28 of the side frame members 20, 22 provide the modular animal containment panel with a drainage feature. More specifically, as illustrated at FIG. 3, where the bottom frame member 18 abuts the side frame members 20, 22, the respective groove 28 of each of the side frame members 20, 22 defines an opening between the side frame member 20, 22 and the bottom frame member 18. When rain and other moisture collect at and trickle down the modular animal containment panel 10, the moisture makes its way to and is collected within the groove 28 of the bottom frame member 18. Under the force of gravity, the moisture collected within the groove 28 of the bottom frame member 18 is channeled to and through the opening defined by the side frame member 20, 22 and the bottom frame member 18. Moisture passing through the opening is directed toward a solitary location at the ground such that the moisture does not gather about the bottom frame member 18.

Considering the above discussion, the modular animal containment panel 10 provides for a welded wire mesh-based animal containment that is adapted for post-manufacture assembly. More specifically, because the welded wire mesh panel 14 is not welded to the frame 12, the animal containment panel 10 can be assembled by, for example, a consumer. As a result, the animal containment panel 10 can be stored and shipped in a disassembled state, which enables the animal containment panel 10 to be stored and shipped using a fraction of the space required by conventional animal containment panels. Although a specific embodiment of the modular animal containment panel 10 has been illustrated and discussed above, it should be noted that the frame members 16-22 can have different sizes and contours and cooperate with one another in ways other than those discussed without departing from the scope or spirit of the present invention. Accordingly, the welded wire mesh panel 14 can have a size and contour different from those discussed above without departing from the scope or spirit of the present invention.

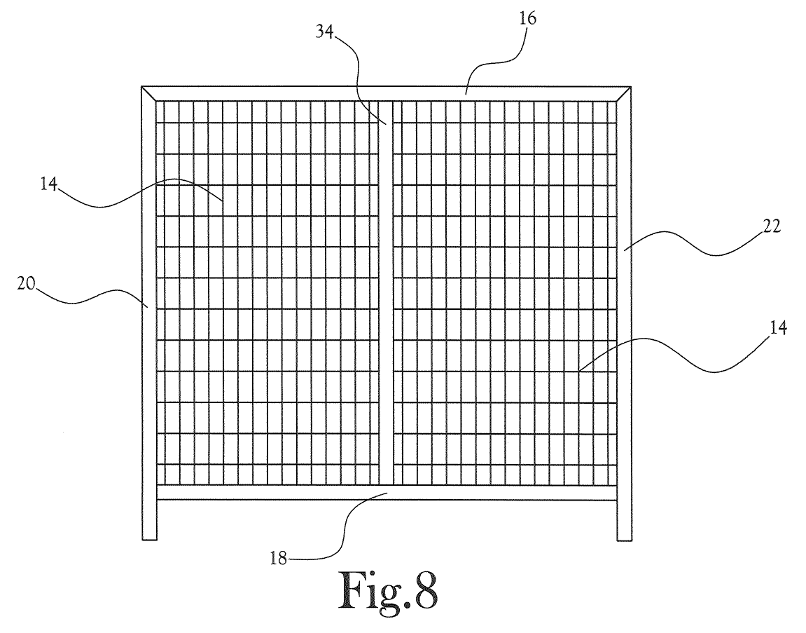

FIG. 8 illustrates an alternate embodiment of the frame 12 in accordance with the various features of the present invention. In this alternate embodiment, the frame 12 includes a joinder frame member 34. The joinder frame member 34 is adapted to receive at least two welded wire mesh panels 14 such that the joinder frame member 34 serves as a joint for connecting the at least two panels 14. FIG. 9 illustrates one embodiment of the joinder frame member 34 illustrated in FIG. 8 in accordance with the various features of the present invention. In the illustrated embodiment, the joinder frame member 34 defines two grooves 28 and two channels 32 positioned such that the grooves 28 open in opposite directions with respect to the frame member 34. It should be noted that the number of grooves 28 and channels 32 defined by the joinder frame member 34 and the positional relationship among the multiple grooves 28 can vary without departing from the scope or spirit of the present invention. The joinder frame member 34 enables a large and stable animal containment to be constructed without an excessive use of single animal containment panels 10 similar to those illustrated at FIG. 3.

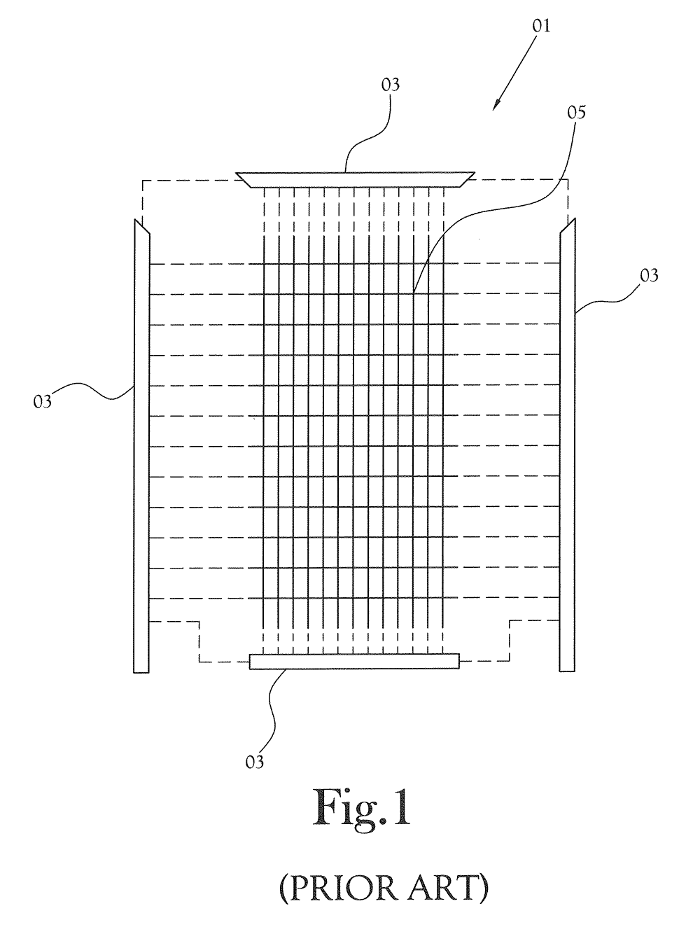

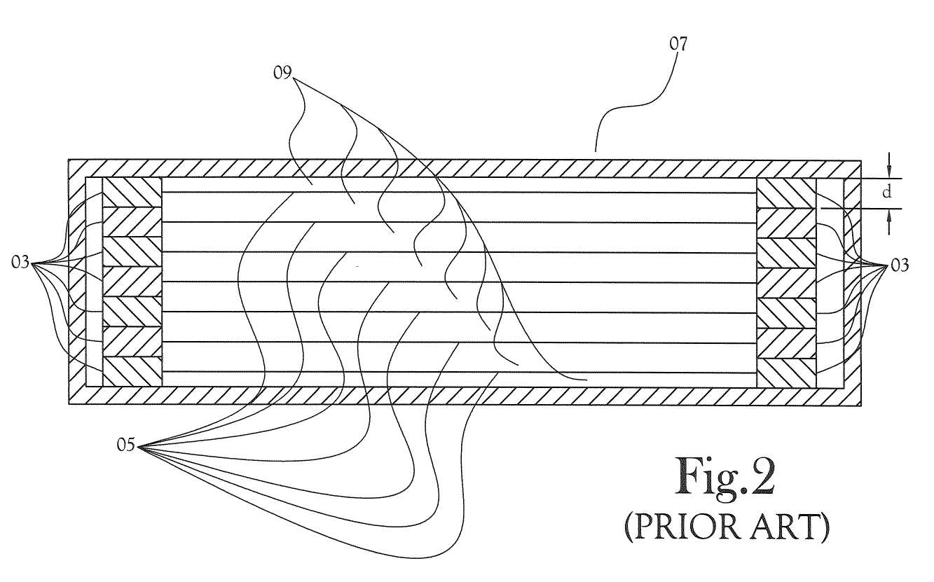

Considering the above discussion, the modular animal containment panel 10 can be used to construct, among other things, animal kennels and animal crates without departing from the scope or spirit of the present invention. More specifically, a kennel constructed using the modular animal containment panels 10 defines the containment area 17 and has an open top and bottom, as illustrated at FIG. 1. Alternatively, a crate constructed using the modular animal containment panels 10 defines a containment area and includes a top containment panel 10 and/or a bottom containment panel 10 such the containment panels 10 defines a substantial enclosure. Additionally, the modular animal containment panel 10 can be sized and conditioned to be suitable for either indoor or outdoor use. More specifically, when the animal containment panel 10 is adapted for indoor use, the size of the panel 10 can be reduced to accommodate limited indoor space. Alternatively, when the animal containment panel 10 is adapted for outdoor use, the metal components of the panel 10 can be treated to prevent rusting.

From the foregoing description, those skilled in the art will recognize that a welded wire mesh-based modular animal containment panel offering advantages over the prior art has been provided. More specifically, the modular animal containment panel includes a welded wire mesh panel that provides the durability required by animal containment. However, the frame of the animal containment panel is adapted to receive the welded wire mesh panel such that the welded wire mesh panel is not welded to the frame. As a result, the animal containment panel can be assembled by, for example, the consumer such that the animal containment panel can be shipped prior to assembly. Shipping the animal containment panel in a disassembled state reduces the size of the packaging required for the animal containment panel, thus reducing the cost of shipping and storing the animal containment panel.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. A modular animal containment panel adapted for post-manufacture assembly, said modular animal containment panel comprising:
a welded wire mesh panel having a plurality of overlaying wires and defining a perimeter, the plurality of overlaying wires including a plurality of perimeter wires, each side of the perimeter being defined by a respective one of the plurality of perimeter wires; and
a frame having a plurality of frame members, each of the plurality of frame members corresponding to one of the sides of the perimeter of said welded wire mesh panel, each of the plurality of frame members defining a groove and a channel, the groove and channel of each of the plurality of frame members being adapted to receive said welded wire mesh panel at the corresponding side of the perimeter thereof such that the corresponding frame member is secured to said welded wire mesh panel, the plurality of frame members being adapted to cooperate with one another such that said frame is secured to said welded wire mesh panel without a weld.

2. The modular animal containment panel of claim 1 wherein the plurality of overlaying wires includes a plurality of horizontal wires and a plurality of vertical wires, the horizontal wires being overlayed by the plurality of vertical wires.

3. The modular animal containment panel of claim 2 wherein the perimeter of said welded wire mesh panel has a rectangular contour, two of the plurality of horizontal wires being perimeter wires that define respective opposing sides of the perimeter, two of the plurality of vertical wires being perimeter wires that define respective opposing sides of the perimeter.

4. The modular animal containment panel of claim 1 wherein the groove and channel of each of the plurality of frame members extend longitudinally along the respective one of the plurality of frame members.

5. The modular animal containment panel of claim 1 wherein the channel of each of the plurality of frame members is adapted to receive the perimeter wire that defines the corresponding side of the perimeter of said welded wire mesh panel.

6. The modular animal containment panel of claim 5 wherein the channel of each of the plurality of frame members receives the corresponding perimeter wire when one end of the perimeter wire is inserted into one end of the channel and the corresponding frame member is moved with respect to said welded wire mesh panel to the extent that a substantial portion of the perimeter wire is positioned within the channel.

7. The modular animal containment panel of claim 5 wherein the channel of each of the plurality of frame members has a size and contour substantially that of the corresponding perimeter wire.

8. The modular animal containment panel of claim 1 wherein the groove of each of the plurality of frame members has a width that is substantially the diameter of the wires of the plurality of overlaying wires that are welded to the corresponding perimeter wire.

9. The modular animal containment panel of claim 1 wherein the grooves defined by certain of the plurality of frame members provide a moisture drainage feature.

10. The modular animal containment panel of claim 1 comprising a plurality of welded wire mesh panels, the plurality of frame members including a joinder frame member, the joinder frame member defining a plurality of grooves and channels, one of the plurality of grooves and channels being adapted to receive one of the plurality of welded wire mesh panels, another of the plurality of grooves and channels being adapted to receive another of the plurality of welded wire mesh panels such that at least two of the plurality of welded wire mesh panel are joined by the joinder frame member.

11. The modular animal containment panel of claim 1 wherein said modular animal containment panel is adapted to cooperate with other modular animal containment panels to define a kennel having an open top and/or an open bottom.

12. The modular animal containment panel of claim 1 wherein said modular animal containment panel is adapted to cooperate with other modular animal containment panels to define a crate having a closed top and/or a closed bottom.

13. The modular animal containment panel of claim 1 wherein said modular animal containment panel is adapted for indoor use.

14. The modular animal containment panel of claim 1 wherein said modular animal containment panel is adapted for outdoor use.

15. A modular animal containment panel adapted for post-manufacture assembly, said modular animal containment panel comprising:
a welded wire mesh panel having a plurality of horizontal wires and a plurality of vertical wires, the plurality of horizontal wires being overlayed by the plurality of vertical wires, the plurality of horizontal wires having a top perimeter wire and a bottom perimeter wire, the plurality of vertical wires having a first side perimeter wire and a second side perimeter wire, the top perimeter wire, the bottom perimeter wire, the first side perimeter wire, and the second side perimeter wire define the perimeter of said welded wire mesh panel; and
a frame comprising:
a top frame member defining a top groove and channel that extend longitudinally along said top frame member, the top groove and channel being adapted to receive the top perimeter wire such that the top frame member is secured to said welded wire mesh panel;
a bottom frame member defining a bottom groove and channel that extend longitudinally along said bottom frame member, the bottom groove and channel being adapted to receive the bottom perimeter wire such that the bottom frame member is secured to said welded wire mesh panel;
a first side frame member defining a first side groove and channel that extend longitudinally along said first side frame member, the first side groove and channel being adapted to receive the first side perimeter wire such that the first side frame member is secured to said welded wire mesh panel; and
a second side frame member defining a second side groove and channel that extend longitudinally along said second side frame member, the second side groove and channel being adapted to receive the second side perimeter wire such that the second side frame member is secured to said welded wire mesh panel;
the top frame member, the bottom frame member, the first side frame member, and the second side frame member being adapted to cooperate with one another when secured to said welded wire mesh panel such that said frame is adapted to be secured to said welded wire mesh panel without a weld.

16. The modular animal containment panel of claim 15 wherein each of the channels has a size and contour substantially that of the perimeter wire adapted to be received thereby.

17. The modular animal containment panel of claim 15 wherein the top groove and the bottom groove have a width that is substantially the diameter of the wires of the plurality of vertical wires, the first side groove and the second side groove having a width that is substantially the diameter of the wires of the plurality of horizontal wires.

18. The modular animal containment panel of claim 15 wherein the grooves defined by the first side frame member, the second side frame member, and the bottom frame member provide a moisture drainage feature when said frame is secured to said welded wire mesh panel.

19. The modular animal containment panel of claim 15 wherein the top groove and channel receive the top perimeter wire when an end of the top perimeter wire is inserted into an end of the top groove and channel and the top frame member is moved with respect to the top perimeter wire to the extent that at least a substantial portion of the top perimeter wire is positioned within the top channel.

20. The modular animal containment panel of claim 15 wherein bottom groove and channel receive the bottom perimeter wire when an end of the bottom perimeter wire is inserted into an end of the bottom groove and channel and the bottom frame member is moved with respect to the bottom perimeter wire to the extent that at least a substantial portion of the bottom perimeter wire is positioned within the bottom channel.

21. The modular animal containment panel of claim 15 wherein the first side groove and channel receive the first side perimeter wire when an end of the first side perimeter wire is inserted into an end of the first side groove and channel and the first side frame member is moved with respect to the first side perimeter wire to the extent that at least a substantial portion of the first side perimeter wire is positioned within the first side channel.

22. The modular animal containment panel of claim 15 wherein the second side groove and channel receive the second side perimeter wire when an end of the second side perimeter wire is inserted into an end of the second side groove and channel and the second side frame member is moved with respect to the second side perimeter wire to the extent that at least a substantial portion of the second side perimeter wire is positioned within the second side channel.

23. A modular animal containment panel adapted for post-manufacture assembly, said modular animal containment panel comprising:
a plurality of welded wire mesh panels, each of said plurality of welded wire mesh panels having a plurality of horizontal wires and a plurality of vertical wires, the plurality of horizontal wires being overlayed by the plurality of vertical wires, the plurality of horizontal wires having a top perimeter wire and a bottom perimeter wire, the plurality of vertical wires having a first side perimeter wire and a second side perimeter wire, the top perimeter wire, the bottom perimeter wire, the first side perimeter wire, and the second side perimeter wire define the perimeter of each respective one of said plurality of welded wire mesh panels; and
a frame comprising:
a top frame member defining a top groove and channel that extend longitudinally along the top frame member, the top groove and channel being adapted to receive the top perimeter wire of each of said plurality of welded wire mesh panels such that the top frame member is secured to each of said plurality of welded wire mesh panels;
a bottom frame member defining a bottom groove and channel that extend longitudinally along the bottom frame member, the bottom groove and channel being adapted to receive the bottom perimeter wire of each of said plurality of welded wire mesh panels such that the bottom frame member is secured to each of said plurality welded wire mesh panels;
a first side frame member defining a first side groove and channel that extend longitudinally along the first side frame member, the first side groove and channel being adapted to receive the first side perimeter wire of one of said plurality of welded wire mesh panels such that the first side frame member is secured to that one of said plurality of welded wire mesh panels;
a second side frame member defining a second side groove and channel that extend longitudinally along the second side frame member, the second side groove and channel being adapted to receive the second side perimeter wire of one of said plurality of welded wire mesh panels such that the second side frame member is secured to that one of said plurality of welded wire mesh panels; and
a joinder frame member defining a plurality of joinder grooves and channels, one of the joinder grooves and channels being adapted to receive the first side perimeter wire of one of said plurality of welded wire mesh panels such that the joinder frame member is secured to that one of said plurality of welded wire mesh panels, another of the joinder grooves and channels being adapted to receive the second side perimeter wire of another of said plurality of welded wire mesh panels such that the joinder frame member is secured to that one of said plurality of welded wire mesh panels;
the top frame member, the bottom frame member, the first side frame member, the second side frame member, and the joinder frame member being adapted to cooperate with one another when secured to said plurality of welded wire mesh panels such that said frame is adapted to be secured to said plurality of welded wire mesh panels without a weld.

24. The modular animal containment panel of claim 23 wherein the joinder frame member defines a first joinder groove and channel and a second joinder groove and channel.

25. The modular animal containment panel of claim 24 wherein the first joinder groove and channel are positioned opposite the second joinder groove and channel with respect to the joinder frame member.

26. The modular animal containment panel of claim 24 wherein the first joinder groove and channel are displaced ninety degrees (90°) from the second joinder groove and channel.
